(19) United States
(12) Patent Application Publication
(10) Pub. No.: US 2011/0166490 A1
(43) Pub. Date: Jul. 7, 2011

(54) Smart Servo for a Mechanical CPR System

(75) Inventors: Pierre H. Woerlee, Valkenswaard (NL); Thomas J. De Hoog, Liempde (NL); Igor W. F. Paulussen, Nuenen (NL); Shervin Ayati, Carlisle, MA (US)

(73) Assignee: KONINKLIJKE PHILIPS ELECTRONICS N.V., Eindhoven (NL)

(21) Appl. No.: 12/997,897

(22) PCT Filed: Jun. 19, 2009
(86) PCT No.: PCT/IB09/52631

§ 371 Date: Dec. 14, 2010

(30) Foreign Application Priority Data
Jun. 26, 2008 (EP) 08159058.0

(51) Int. Cl. A61H 31/00

(52) U.S. Cl. 601/41

(57) ABSTRACT

The invention relates to an apparatus and a method for automated Cardio Pulmonary Resuscitation. The apparatus comprises a chest compression actuator, an actuator driver that supplies time-varying drive signals to the chest compression actuator in dependence of operating parameters of the actuator driver, a physiological parameter sensor supplying measured values of a physiological parameter related to the function of the chest compression actuator, and an adaptive control for the operating parameters of the actuator driver. The operating parameters determining a dynamic behavior of a system comprising the chest compression actuator and a chest of a patient.

### FIELD OF THE INVENTION

The invention relates to the field of automated cardiopulmonary resuscitation apparatuses, and more specifically to a control for a chest compression actuator.

### BACKGROUND OF THE INVENTION

Cardiopulmonary resuscitation (CPR) is a well-known technique for increasing the chance for survival from cardiac arrest. However, it is very difficult to perform consistent high quality manual cardiopulmonary resuscitation. Since CPR quality is key for survival there is a strong drive to have a mechanical automated device to replace less reliable and long duration manual chest compressions. Automated CPR (A-CPR) systems were introduced in the market recently.

Some A-CPR systems use a pneumatic actuator mechanism while other A-CPR systems are driven by an electrical motor such as a servo motor. Patent application publication US 2007/0270724 A1 describes a servo motor for CPR that features a control of the compression wave form as applied to the patient. To this end US 2007/0270724 A1 proposes to adjust the set point wave form. This leads to improved therapy concerning both blood flow and avoidance of internal injuries, because the desired wave form can be chosen relatively close to upper limits that should never be exceeded.

Typically, a servomotor and its control use a feed-forward part (how well does the actuator follow the commanded motion, i.e. signal sent in advance to the motor to have accurate following) and a disturbance control part (rejection of disturbances i.e. deviations from the desired motion, i.e. (accidental) deviations from the commanded motion). The feed-forward control part is an estimated actuator force-versus-time (or in this case current or voltage) which is needed to follow the desired motion as good as possible (i.e. within an average or maximum error). In conventional servo techniques the feed-forward control is calculated once and a detailed model of the system and the servo system is required. For automated cardio pulmonary resuscitation this part needs to be estimated for every patient and large differences may occur. The most often used implementation for disturbance correction of a servo motor/control is the so called Proportional-Integral-Derivative (PID) control. The setting of the gains for the P, I, and D parts is not trivial, too high gains may lead to instability and it may require significant time to optimize the gains such that the disturbance is corrected while avoiding under- and overshoots.

### SUMMARY OF THE INVENTION

The use of a servomotor for automated CPR on humans and animals is not trivial because of differences and variability during CPR in the mechanical load properties of a human thorax. Firstly, the visco-elastic behavior of the human thorax being very complex and non-linear, an accurate model of the thorax of the specific patient is lacking. Moreover, there is a large variation in the visco-elastic properties of humans; this has to be accounted for since the compression waveform has to be identical for the different patients. Overshoots (i.e. more deep compressions than desired) can be very dangerous and may cause lethal body damage. It is also known that the visco-elastic properties of the body change during CPR (i.e. the thorax becomes less stiff). Finally, there is little time to optimize the PID settings and estimate the feed-forward control, every second counts during resuscitation.

In relation to the present invention it has been found that the mechanical system comprising the chest of the patient and a chest compression actuator is subject to significant variations due to for example the stature of the patient, the placement of the actuator, and various other factors. The mechanical system is at least of second order which means that it is capable of oscillations. The mechanical system is also subject to overshoots. If these properties of the mechanical system are not properly taken in consideration, the oscillations and/or the overshoots may come dangerously close to the allowed limit or even exceed those limits. A major worry is injuries to the chest and thorax (broken ribs, sternum organ rupture). Reducing the set point wave form to a setting that results in a system response with sufficient margin between the overshoots and the allowable limits is an option. However, then the chest compression action is not as efficient as it could be. Furthermore, even small overshoots and oscillations may lead to corresponding irregularities in the blood flow of the patient and therefore negatively affect blood perfusion.

The mechanical properties of the chest and the thorax are subject to wide variations depending on the stature of the patient. The mechanical properties may even vary quite significantly during performing the cardio pulmonary resuscitation: The thorax becomes less stiff and full chest relaxation does not occur anymore.

It would be desirable to achieve an automated cardiopulmonary resuscitation apparatus that reduces or even eliminates overshoots and oscillations in the chest compression movement regardless of the dynamic behavior of the mechanical chest-actuator system. It would also be desirable to achieve an automated cardiopulmonary resuscitation apparatus that adapts to changes in the dynamic behavior of the mechanical system comprising the chest of the patient and the chest compression actuator.

To better address one or more of these concerns, in a first aspect of the invention an automated cardiopulmonary resuscitation apparatus is presented that comprises a chest compression actuator, an actuator driver that supplies time-varying drive signals to the chest compression actuator in dependence of operating parameters of the actuator driver, the operating parameters determining a dynamic behavior of a system comprising the chest compression actuator and a chest of a patient, a physiological parameter sensor supplying measured values of a physiological parameter related to the function of the chest compression actuator, and an adaptive control for the operating parameters of the actuator driver, wherein the adaptive control receives the measure values and evaluates them with respect to compliance with predetermined conditions.

To better address one or more of the above mentioned concerns, in a second aspect of the invention a method for automated cardiopulmonary resuscitation is presented that comprises:

a) setting operating parameters that determine dynamic behavior of a system comprising a chest of a patient and a chest compression actuator of an automated cardiopulmonary resuscitation apparatus to save initial values,
b) the automated cardiopulmonary resuscitation apparatus performing at least one chest compression,
c) collecting a measured value of a resuscitation related physiological parameter,
d) evaluating the measured value with respect to compliance with predetermined conditions,
e) modifying the operating parameters according to an adaptive control scheme using a result of evaluating the measured value.

To better address one or more of the above mentioned concerns, in a third aspect of the invention a signal is presented that is transmitted from an adaptive control to an actuator driver of an automated cardiopulmonary resuscitation apparatus. The signal comprises instructions to the actuator driver to modify operating parameters that determine a dynamic behavior of a system comprising a chest of a patient and a chest compression actuator of the automated cardiopulmonary resuscitation apparatus.

To better address one or more of the above mentioned concerns, in a fourth aspect of the invention a computer program is presented that enables a processor to carry out the method of the third aspect of the invention.

The different embodiments of the invention may solve one or several of the following problems:

Very accurate following of arbitrary (realistic) displacement versus time compression shapes for a wide range of patients (consistent and no variation during CPR).

Mimics best known (manual) complex CPR compression waveforms

An accurate mechanical model of the human thorax (the load) is not required in some embodiments

The servo control is adaptive, i.e. follows changes in the load (i.e. body) automatically

The servo system automatically adjusts for different patient size, weight and properties

The set up time is very short because the procedure is automated

Allow personalization of CPR to the patient by using mechanical parameter(s) of the patient at the start and during CPR (including using these parameters in a feed back loop)

By careful control of the compression depth and shape, thorax and organ damage can be minimized.

Start up procedure optimized to avoid/minimize the possibility of body damage related to CPR.

It would be further desirable to provide an automated cardiopulmonary resuscitation apparatus that is capable of reacting to disturbances affecting the response of the mechanical apparatus. In an embodiment this concern is addressed by the actuator driver comprising a controller that receives the measured values and a corresponding desired value and generates closed loop control signals for the chest compression actuator. It would be desirable to modify operating parameters that are easily alterable and have a certain degree of influence on the dynamic behavior or the response of the mechanical system. In an embodiment this concern is addressed in that the operating parameters of the actuator driver subject to the adaptive control comprise at least one among a gain of the controller and the desired value.

It would be desirable to provide an automated cardiopulmonary resuscitation apparatus that allows a safe, meaningful, and fast evaluation of the dynamic behavior of the mechanical system. In an embodiment one or more of these concerns is addressed by the adaptive control comprising an iterative learning control that receives the measured values and a corresponding desired value, and generates control signals for the chest compression actuator in an iterative manner based on a previous control signal and the difference between the measured value and the desired value.

It would be desirable that the iterative learning control converges to a solution that assures a high degree of conformance between an actual output of the mechanical system chest-actuator and a desired wave form. In an embodiment this concern is addressed by the difference between the measured value and the desired value being differentiated with respect to time. The result of the differentiation tends to zero as the difference between the measured value and the desired value becomes more and more constant.

It would be desirable that the iterative learning control is stable. This concern is addressed by the iterative learning control being defined by an iterative learning law as follows:

$${u}_{k + 1} ( t ) = {u}_{k} ( t ) + γ \cdot \frac{d}{d t} {e}_{k} ( t ) ,$$

where uₖ(t) is a control signal for the chest compression actuator during a current time interval,

uₖ₊₁ (t) is a control signal for the chest compression actuator during a subsequent time interval,

γ is an iterative learning gain,

eₖ is the difference between the desired value and the measured value.

Stability can be achieved for appropriate values of γ.

It would be desirable to achieve a control of a chest compression actuator within an automated cardiopulmonary resuscitation apparatus that reduces or even eliminates overshoots and oscillations in the chest compression movement regardless of the dynamic behavior of the mechanical chest-actuator system. It would also be desirable to achieve a control of a chest compression actuator within an automated cardiopulmonary resuscitation apparatus that adapts the action of the actuator to changes in the dynamic behavior of the mechanical system comprising the chest of the patient and the chest compression actuator.

To better address one or more of these concerns, in a further aspect of the invention a signal is proposed that is transmitted from an adaptive control to an actuator driver of an automated Cardio Pulmonary Resuscitation system. The signal comprises instructions to the actuator driver to modify operating parameters that determine a dynamic behavior of a system comprising a chest of a patient and a chest compression actuator of the automated Cardio Pulmonary Resuscitation apparatus.

In a further aspect of the invention, a computer program product is proposed that enables a processor to carry out the method described above.

The basic idea is to take into consideration the varying dynamic behavior of the mechanical system chest-actuator. Nevertheless, a theoretical model of the mechanical system is not needed. Automated cardio pulmonary resuscitation should start gently to avoid thorax damage. An adaptive gain of the controller settings is important (i.e. do not use too high gains initially, change gain during reanimation). A reliable estimation of feedforward input signal of the servo system is needed. An adaptive optimization of cardio pulmonary resuscitation by iterative learning control of the feedforward part of the control may contribute to a satisfactory performance of the system. The recommended compression pulse has to be followed very accurately or else severe body damage or reduced perfusion can result. Moreover, the adaptivity and self-learning of the system is presently not well understood in the CPR environment.

These and other aspects of the invention will be apparent from and elucidated with reference to the embodiment(s) described herein after.

### BRIEF DESCRIPTION OF THE DRAWINGS

FIG. 1 shows an automated cardio pulmonary resuscitation apparatus according to a first aspect of the invention.

FIG. 2 shows an automated cardio pulmonary resuscitation apparatus according to a second aspect of the invention.

FIG. 3 shows a flow chart of a method for automated cardio pulmonary resuscitation according to a first aspect of the invention.

FIG. 4 shows a flow chart of a method for automated cardio pulmonary resuscitation according to a second aspect of the invention.

FIG. 5 shows a control scheme of a servo motor system.

FIG. 6 shows a flow chart of automated cardio pulmonary resuscitation start-up with adaptive PID control.

FIG. 7 shows the control scheme of an iterative learning control system (ILC).

FIG. 8 shows two time diagrams of the desired compression waveform and the actual compression waveform in the case of a PID controller having a low proportional gain.

FIG. 9 shows two time diagrams of the desired compression waveform and the actual compression waveform in the case of a PID controller having a high proportional gain.

FIG. 10 shows two time diagrams of the desired compression waveform and the actual compression waveform in the case of an iterative learning controller including a conventional PID controller.

### DETAILED DESCRIPTION OF THE EMBODIMENTS

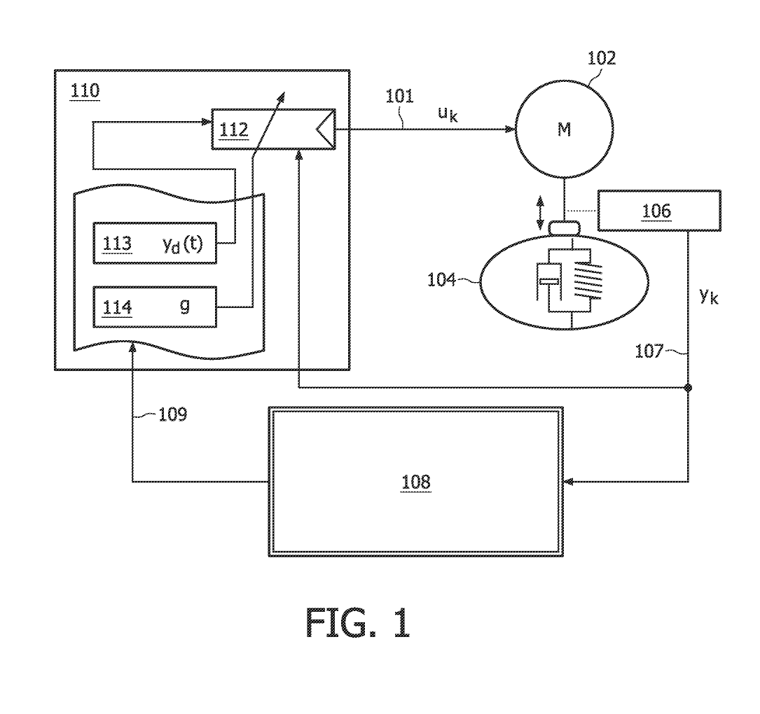

FIG. 1 shows a schematic block diagram of an automated cardio pulmonary resuscitation apparatus according to a first aspect of the invention. The automated cardio resuscitation apparatus uses a chest compression actuator 102 that exerts a force on a human chest 104 by use of e.g. a pad and a piston. The chest 104 is not a part of the automated cardio pulmonary resuscitation apparatus and is represented by a mechanical model that approximates the mechanical behavior of the chest 104. The mechanical model can be represented by a spring and a damper connected in parallel. The movement of the pad, and consequently also the compression of the chest, is detected by a physiological parameter sensor 106 that provides measurements for the actual chest compression yₖ. The measurements of the actual chest compression yₖ are supplied, by means of a connection for the measurements for the actual chest compression 107, to a controller 112 that compares the actual chest compression yₖ with a desired waveform for the chest compression y_{d} and determines a drive signal uₖ for the chest compression actuator 102. The drive signal uₖ is supplied to the chest compression actuator 102 by means of a connection 101. The chest compression actuator 102, the chest of the patient 104, the physiological parameter sensor 106, and the controller 112 form a closed loop control system.

It has been found that the mechanical properties of the chest 104 are subject to significant variations, not only from one patient to another, but also over time for a single patient. An automated cardio pulmonary resuscitation apparatus has to cope with a wide range of patient size and weight, with a large freedom in the shape of the compression pulse, and with low risk to damage the thorax and vital organs. The desired compression waveform has to be followed accurately without user intervention. A controller 112 having fixed settings is hardly able to achieve this. Therefore, the automated cardio pulmonary resuscitation apparatus represented in FIG. 1 comprises means to tune the controller 112 to the visco-elastic properties of the thorax of the patient.

The controller 112 is part of an actuator driver 110 that comprises some memory for operating parameters 113 and 114. Operating parameter 113 is the desired waveform y_{d}(t) that is used as a setpoint signal for controller 112. Operating parameter 114 is the gain g of the controller 112. The operating parameters 113 and 114 are adjusted by an adaptive control 108 that receives the measurements of the actual compression waveform yₖ as an input and analyses the measurements with respect to the quality of the actual compression waveform. The adaptive control 108 may compare certain properties of the actual compression waveform with preselected values such as the peak compression depth, the compression velocity, and the like. Adaptive control 108 might determine whether the preselected values or exceeded by the actual compression waveform yₖ. Another alternative would be to have adaptive control 108 compare the actual compression waveform yₖ with prestored compression waveforms that are considered to be optimal, near-optimal and/or undesired. Based on the analysis adaptive control 108 provides an output on connection 109 to the actuator driver, and in particular to the section where the operating parameters 113 and 114 are stored. Other operating parameters besides the desired compression waveform y_{d}(t) 113 and controller gain g 114 are also possible, such as the gains of the integrator part and the derivative part in a PID controller.

The human thorax with its non-linear visco-elastic properties is schematically illustrated. The automated cardio pulmonary resuscitation apparatus consists of a pad, a transmission and motion conversion unit, e.g. from rotation to linear, a servo motor 102, an amplifier (not individually shown, but could be part of controller 112), and a servo control 110. A desired compression depth and pulse shape of the sternum versus time is used as initial input for the estimation of the signal in the feedforward loop comprising operating parameter of the desired compression waveform y_{d}(t) and controller 112. The desired and actual compression waveform and depth are compared and the error signal is minimized to a certain limit by the servo system. The feedback loop required for the servo systems contains at least one physiological parameter related to the patient, preferably the displacement of the chest of the patient versus time. Other parameters obtained from the patient could be the visco-elastic properties of the thorax (i.e. stiffness, damping, etc.) obtained from the measured force-displacement relation using for instance an accelerometer or other measuring device (optical, electrical, etc.).

A brushless electrical motor (e.g. a Maxon EC-MAX 40 120 W motor, with recommended gear head) is chosen for the chest compression actuator 102. Other types of motors (i.e. higher power, other type like linear motor) are also possible.

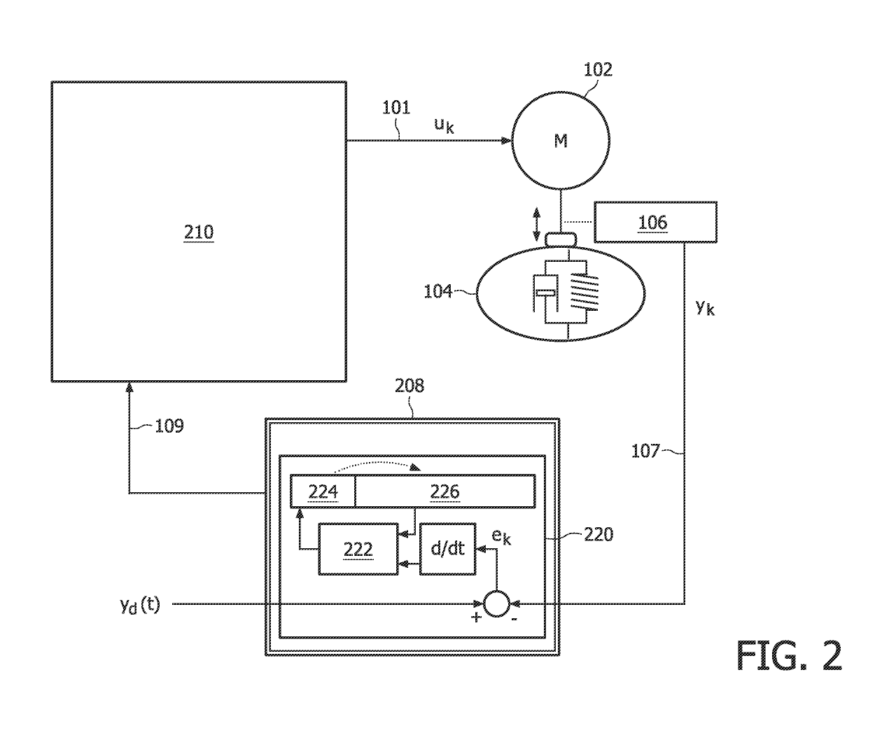

FIG. 2 shows a schematic block diagram of an automated cardio pulmonary resuscitation apparatus according to a second aspect. The part of the apparatus around the chest compression actuator 102, the human chest 104, and the physiological parameter sensor is identical or similar to what is illustrated in FIG. 1. However, the feedback control loop is now incorporated in the adaptive control 208. The measurements of the actual compression waveform yₖ reach adaptive control 208 by means of connection 107. The measurements of the actual compression waveform yₖ and an iterative learning control (ILC) 220 within adaptive control 208. An iterative learning control automatically updates the system input uₖ of compression k until the error signal eₖ (i.e. the deviation between the measured yₖ and the desired compression y_{d}) is minimized. Prior knowledge of the load is not needed. A desired compression waveform y_{d}(t) is also input to adaptive control 208 and iterative learning control 220. The difference between the desired compression waveform y_{d}(t) and the actual compression waveform yₖ is determined and yields an error eₖ. The block d/dt determines the derivative with respect to time of the error eₖ and passes the calculated value on to a control signal calculator 222. Another input for control signal calculator 220 is provided by a memory/storage 226 for previous control signals. Based on its two inputs and an iterative learning law, control signal calculator 222 calculates a current control signal which is stored memory/storage 224 for the current control signal. The iterative learning law could have the following form:

$${u}_{k + 1} ( t ) = {u}_{k} ( t ) + γ \cdot \frac{d}{d t} {e}_{k} ( t ) .$$

In this formula, uₖ(t) is the system input (drive signal) which could be force or current the k′th compression at time (t), and eₖ(t) is the error signal at time t. The factor γ (gamma) is the gain of the iterative learning law. In this way the feedforward signal converges to an optimal value and the displacement converges very closely to the desired compression waveform y_{d}(t). Note that the above equation is only used as an example; there are many more algorithms. It is important to know that the initial feedforward signal and the gain y are chosen conservatively to avoid thorax damage. A simple PID controller is included to correct for disturbances. It is possible that the disturbance controller can be different from the one illustrated in FIG. 1. For the system illustrated in FIG. 2 prior knowledge of the model of the human thorax is not required, it can adapt to patients with a wide variation in size and weight, and it can cope with variations in the visco-elastic properties of the body. Furthermore, the system is very flexible, e.g. changing to other compression curves is relatively straightforward. Finally, the set-up time is minimized and automated.

Usually, the desired compression waveform y_{d}(t) does not change from one compression to the next, although it might be envisioned to modify the desired compression waveform y_{d}(t) as a function of the overall health condition of the patient. For example, the compression frequency and/or depth could be increased to intensify the cardio-pulmonary resuscitation when the patient has passed into a critical health condition. Nevertheless, for most subsequent compressions the desired compression waveform is the same. The iterative learning control algorithm uses this fact, because any modification of the operating parameters of the automated cardio pulmonary resuscitation apparatus can be checked during the next compression waveform as to whether it was successful, i.e. the error eₖ was reduced. Because the iterative learning control algorithm depends on the control signals that were used during previous compression cycles, these previous control signals need to be stored. In fact, at least the control signal of the immediately preceding compression cycle should be available. As already pointed out above, this could be achieved a memory/storage for previous control signal(s) 226. The current control signal 224 is shifted to memory/storage 226 once the compression cycle for which it was valid, is over. At the same time, older control signals are deleted from memory/storage 226 as they are not needed anymore. The shifting operation from memory/storage 224 to memory/storage 226 is indicated by the dotted arrow in FIG. 2.

The actuator driver 210 in FIG. 2 is different from the actuator driver 110 of FIG. 1. Actuator driver 210 might contain an amplifier, for example.

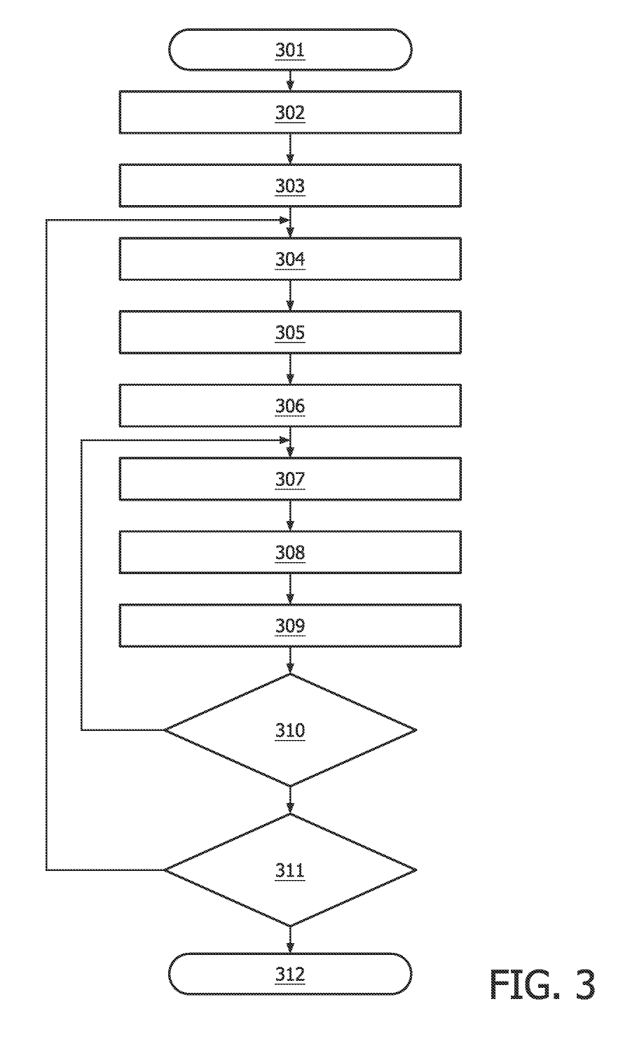

FIG. 3 shows a flow chart of a method for automated cardio pulmonary resuscitation according to a first aspect of this application. The method starts with block 301. In block 302 the operating parameters are set to save initial values. In block 303 at least one chest compression is performed. This allows an initial determination of the visco-elastic behavior of the chest of the current patient and possibly also of other properties of the system formed by the chest compression actuator and the chest. In block 304 the measured values of physiological parameters are collected. Then, in block 305, the measured values are evaluated with respect to predetermined conditions. Based on the result of the evaluation, an adaptive control is performed in block 306 to modify the operating parameters of the control system, e.g. of an inner loop controller. Due to the modified operating parameters, the actual system output is modified. Measured values are received in block 307. In block 308 closed loop control signals are generated by controller 112 (cf. FIG. 1). Another chest compression is performed in step 309. In branching point 310 it is determined whether the next update of operating parameters should be performed. If currently no update of the operating parameters is planned, the method branches back to block 307 in order to continue with normal closed loop control based on the currently valid operating parameters. If an update of the operating parameters should be done, the method arrives at a second branching point 311 within which it is determined whether the cardio pulmonary resuscitation is to be terminated (e.g. due to a corresponding user command). If the answer is yes, the method ends in block 312. If the answer is no, the method branches back to block 304 and thus starts over with collecting measured values of resuscitation related physiological parameters.

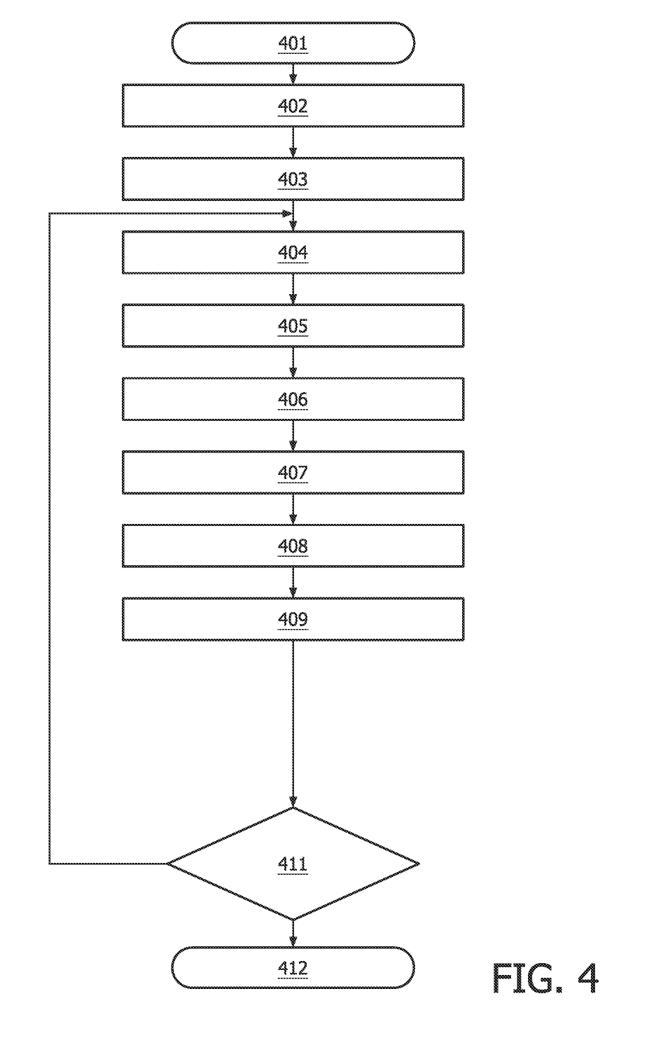

FIG. 4 shows a flow chart of a method for automated cardio pulmonary resuscitation according to a second aspect of the application. The method starts with block 401. As for the method shown in FIG. 3, the operating parameters are set to save initial values in block 402 and in block 403 at least one chest compression is performed. Measured values of resuscitation related physiological parameters are collected in block 404. Then, in block 405, the measured values are evaluated with respect to predetermined conditions. An iterative learning control is performed in block 406 and a control signal is generated in block 407. In block 408, a chest compression according to the control signal is performed. The current control signal is stored during block 409 in order to be available for the next iteration that is performed during the next compression cycle. At branching point 410 a determination is made whether the cardio pulmonary resuscitation should be ended (e.g. based on a corresponding user command or input). If the cardio pulmonary resuscitation is to be continued the method branches back to block 404. In the contrary case, the method ends at block 412.

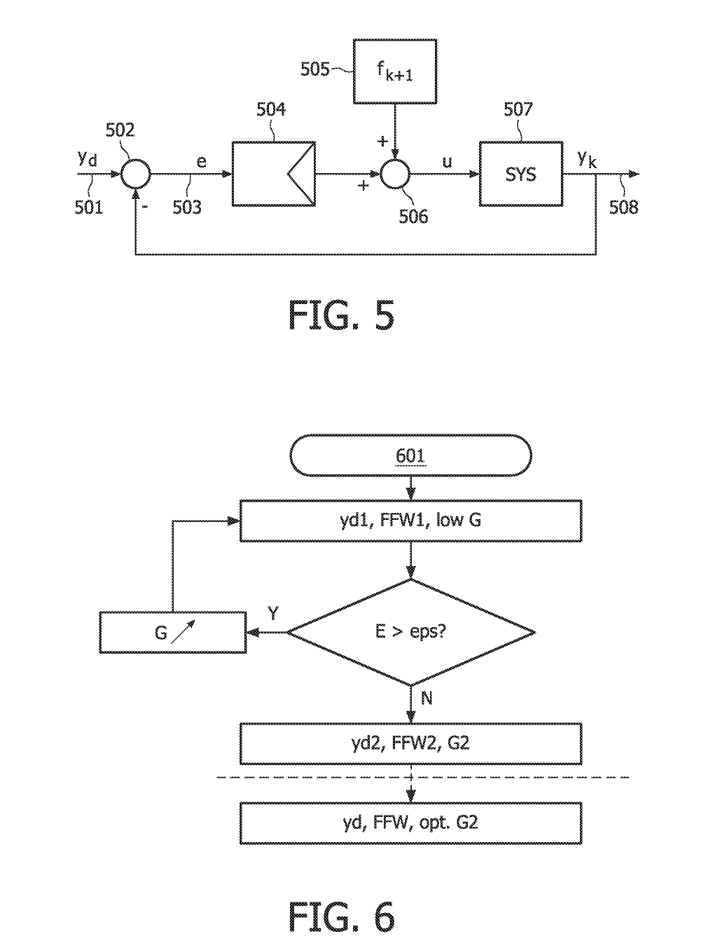

FIG. 5 shows a control scheme for a combined feedforward (FFW) and feedback control. The desired compression waveform y_{d} is input to a summing point 502 by means of connection 501. Another input for the summing point 502 is the actual compression waveform yₖ. The summing point 502 provides an error signal e on connection 503 which enters a (feedback) controller 504. The output of the (feedback) controller 504 is added to a feedforward control signal fₖ₊₁ provided by a feedforward controller 505 at a summing point 506. The sum u of feedback control signal and feedforward control signal is transmitted to the system 507 (SYS). The system 507 reacts with an actual compression waveform yₖ on connection 508 which also has a branch back to the summing point 502.

As is well known, the servo control tries to minimize the error signal, i.e. the difference between the desired compression waveform y_{d} and the measured or actual compression waveform yₖ (the feedback signal). A feedforward (FFW) input is optional, but offers for example a better following of commanded motion. The gain settings that are needed should not be too low (poor following) or too high (system instability, excessive forces possible).

With reference to FIG. 6, the following procedure is proposed to optimize servo control for a specific patient:

Start CPR with low force and low gain settings (blocks 601 and “yd1, FFW1, low G”). These settings could be estimated from the patient's size. Either a default feedforward control input can be used or the optimal feedforward pulse is estimated from physiological data from the patient. The gain settings are adjusted such that the desired motion is followed with a certain error e (e.g. average or maximum) such that the error signal is within a certain desired range ε (eps)-c.f. branching point “e>eps ?”. The force is increased by increasing the feedforward signal and if necessary the PID gains (block “G=G+x”) such that the error signal is within the desired range. The procedure is repeated until the desired depth and compression wave form are reached which is indicated by the error e being below the threshold ε.

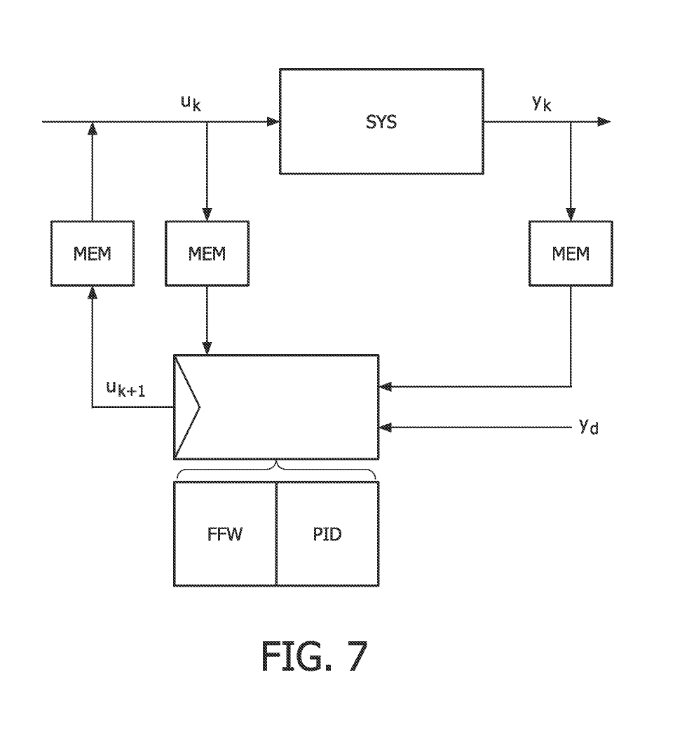

FIG. 7 shows a servo controller for iterative learning control (ILC). Again, the block SYS represents the system comprising principally the chest and the chest compression actuator. It receives the system input (drive signal) uₖ as input and reacts with a measured compression waveform yₖ. Both, the system input uₖ and the measured compression waveform yₖ are supplied to an iterative learning controller via a respective memory MEM. The iterative learning controller produces a system input uₖ₊₁ for the next cycle, which is stored in a further memory MEM until it is used during the next cycle. The two left memories MEM could also be combined, but were drawn separately for the sake of clarity. The iterative learning controller comprises a feedforward part FFW and a simple PID controller for correcting disturbances.

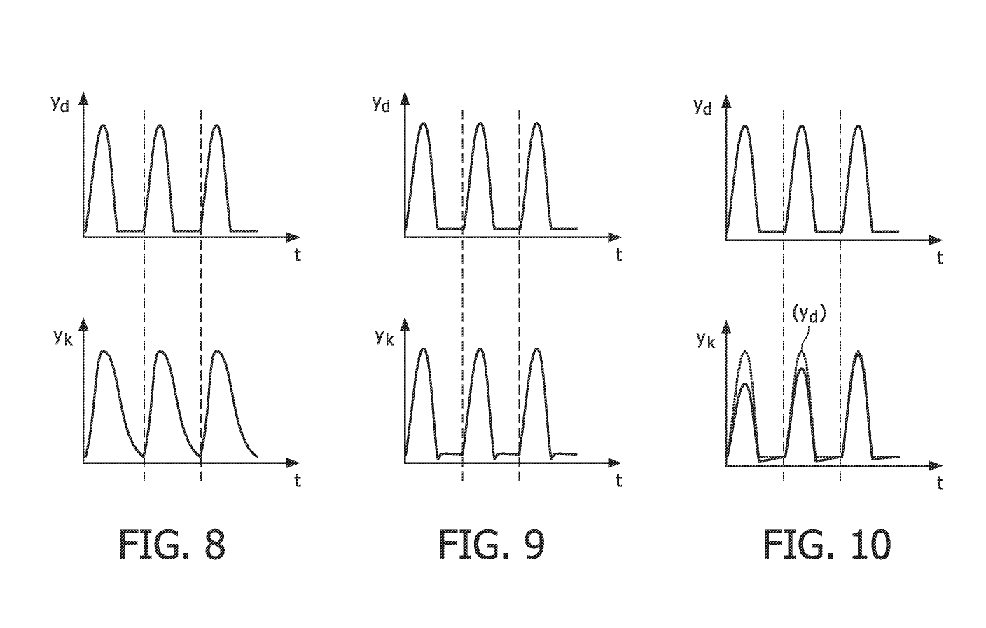

FIGS. 8 to 10 show different time diagrams of the desired compression waveform y_{d} and the actual compression waveform yₖ for different types of controllers. The desired waveform y_{d} is always the same in order to allow a comparison.

FIG. 8 shows the time diagram for the system output yₖ in the case of a PID controller with conservative gain settings. In particular, the proportional gain of the PID controller was chosen to be G=5, the gain of the integrator portion of the PID controller was set to I=0.001, and the gain of the derivative portion of the PID controller was set to D=0.001. Clearly, a gain of 5 is too low, because the desired waveform y_{d} is not very closed replicated by the system output yₖ. In particular, the rise and fall rates are too slow and broaden each compression pulse over time so that two adjacent compression pulses are merged with each other. This might cause a problem for blood perfusion, because the heart has not enough time to relax again before the next compression.

FIG. 9 shows the time diagram for the system output yₖ in the case of a PID controller with relatively high gain settings. While the gains of the integrator portion and the derivative portion are unchanged compared to the settings in the context of FIG. 8, the proportional gain is now G=100. This gain gives good results in terms of the actual compression waveform following the desired compression waveform. However, some ringing and near-instability can be observed, especially around the instant when the compression pulse return to its rest position. FIGS. 8 and 9 illustrate the influence of the gain settings. Increasing the gain further can lead to instability and severe damage to the thorax and organs.

FIG. 10 shows a result of an automated cardio pulmonary resuscitation apparatus based on iterative learning control (ILC). The mechanical system (i.e. the patient) is the same as in the PID cases of FIGS. 8 and 9. It can be observed that the desired compression curve (repeated as dotted line in the lower time diagram for better comparability) is approximated very closely within a few pulses. With iterative learning control, the details of the mechanical system do not need to be known. The optimum feedforward pulse is found automatically, the desired compression pulse is reached quickly and much more accurately than that achieved by the PID controller. Note that a low PID gain can be used and changes in the load are followed automatically.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein a procedure to start and maintain automated CPR is optimal to the specific patient, personalizes the force for the patient, reduces CPR trauma and follows changes in the patient's mechanical load automatically. The feedforward input of the servo system may be estimated. The apparatus and/or the method may attempt to follow a best practice (manual) compression waveform. A wide range of waveforms is possible, new waveforms can be easily introduced. A feedforward input component for a servo for automated CPR or an adaptive servo may be used.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Automated cardio pulmonary resuscitation apparatus, comprising a chest compression actuator for exerting a force on a chest of a patient based on a drive signal,
an actuator driver for supplying time-varying drive signals to the chest compression actuator in dependence of operating parameters of the actuator driver, the operating parameters determining a dynamic behavior of a system comprising the chest compression actuator and the chest,
a physiological parameter sensor for measuring a chest compression waveform resulting from the exerted force on the chest by the chest compression actuator, and
an adaptive control for iteratively determining the drive signal for the chest compression actuator based upon a comparison of the measured chest compression waveform with a desired waveform for chest compression.

2. (canceled)

3. Automated cardio pulmonary resuscitation apparatus according to claim 1, wherein operating parameters of the actuator driver subject to the adaptive control comprise at least one among a gain of the controller and the desired value.

4. (canceled)

5. Automated cardio pulmonary resuscitation apparatus according to claim 1, wherein the comparison is a difference between the measured chest comparison waveform and the desired waveform and differentiates the difference with respect to time.

6. Automated cardio pulmonary resuscitation apparatus according to claim 5, wherein the iteration is defined by an iterative learning law as follows:
$${u}_{k + 1} ( t ) = {u}_{k} ( t ) + γ \cdot \frac{d}{d t} {e}_{k} ( t ) ,$$
where uₖ(t) is a control signal for the chest compression actuator during a current time interval,
uₖ₊₁(t) is a control signal for the chest compression actuator during a subsequent time interval,
γ is an iterative learning gain,
eₖ(t) is the difference between the desired value and the measured value, and d/dt is the derivative with respect to time.

7. Method for automated cardio pulmonary resuscitation, comprising:
a) setting operating parameters that determine a dynamic behavior of a system comprising a chest of a patient and a chest compression actuator of an automated cardio pulmonary resuscitation apparatus to safe initial values, the method further comprising iteratively performing
b) performing at least one chest compression by the cardio pulmonary resuscitation apparatus based on the set operating parameters,
c) collecting a chest compression waveform resulting from the chest compression,
d) evaluating the chest compression waveform with respect to compliance with a desired waveform for chest compression,
e) modifying the operating parameters according to an adaptive control scheme using the evaluation.

8. (canceled)

9. (canceled)

10. Method according to claim 7, wherein evaluating is defined by an iterative learning law as follows:
$${u}_{k + 1} = {u}_{k} + γ \cdot \frac{d}{d t} {e}_{k} ,$$
where uₖ is a control signal for the chest compression actuator during a current time interval,
uₖ₊₁ is a control signal for the chest compression actuator during a subsequent time interval,
γ is an iterative learning gain,
eₖ is the difference between the desired value and the measured value, and d/dt is the derivative with respect to time.

11. (canceled)

12. (canceled)
